(19) United States
(12) Patent Application Publication
(10) Pub. No.: US 2009/0327233 A1
(43) Pub. Date: Dec. 31, 2009

(54) METHOD OF SELECTING OBJECTS IN WEB PAGES

(75) Inventors: Hong-Yung WANG, Sindian City (TW); Ming-Hua CHEN, Sindian City (TW)

Correspondence Address: PATENTTM.US, P. O. BOX 82788, PORTLAND, OR, 97282-0788, US

(73) Assignee: MOBILE ACTION TECHNOLOGY INC., Sindian City (TW)

(21) Appl. No.: 12/163,098

(22) Filed: Jun. 27, 2008

(51) Int. Cl. G06F 7/06; G06F 17/30

(52) U.S. Cl. 707/3; 707/E17.107

(57) ABSTRACT

A method of selecting objects in web pages provides users with conveniently selecting objects of interest in a target web page. With the method of the present invention, it is not necessary for the users to either know the makeup language for the web pages or create a program reserved for capturing required contents in the target web page. The method of the present invention provides an easy operational flow for the users to select required contents in the target web page.

### BACKGROUND OF THE INVENTION

1. Field of the Invention

The present invention relates to a method of selecting objects in web pages, and more particularly to a method that allows users to easily select required contents in the web pages.

2. Description of Related Art

The advancement of the Internet technology has resulted in most electronic devices, such as laptops, desktops, cell phones, etc. being able to connect to the Internet. Internet allows the users to use various kinds of Internet services, such as browsing web pages, communication by instant messaging services, reading electronic mails (emails) or the like.

A so-called HyperText Markup Language (HTML) standard protocol has been created to enrich contents such as text, pictures, videos, music and the like in the web pages and to provide interactive web pages to the users. The HTML is a makeup language for the web pages and can be used to embed contents such as text, pictures, video, music, JavaScript and/or the like in the web pages. Users are able to connect to a web server with their electronic devices that are capable of connecting to the Internet to browse the web pages. The browsers installed in the electronic devices interpret the web pages so the contents of the web pages can be displayed to the users.

With reference to FIG. 12, because the HTML script supports various designs of the web page, a website host can easily design web pages having many different types of contents such as text (41), pictures (42), videos, music, interactive JavaScript, Flash player (43) and the like. Therefore, the website host always enriches many different contents in the web pages of the website to attract more users to browse the website.

However, if the user is interested in a specific content in a target web page, the user cannot only obtain the content of interest because the browser always shows all contents in the target web page. To solve the problem, the required content must be filtered out, captured or transmitted designatedly from the target web page. To select required content from the target web page, the user must be skilled in the HTML script to know how to encoding of the HTML script, choosing objects in the web page and the like.

Moreover, if the required contents in the target web page are frequently updated information, such as the stock quotes charts, real-time traffic status tables, weather charts, real-time updated news or the like, how to update and capture the required real-time information is a difficult and complicated job. The user may ask a programmer to create a specific program for capturing required contents in the target web page. However, end users still cannot easily select required contents in the target web pages.

To overcome the shortcomings, the present invention provides a method of selecting objects in web pages to mitigate or obviate the aforementioned problems.

### SUMMARY OF THE INVENTION

The main objective of the invention is to provide a method that allows users to easily select required contents in the web pages.

The method in accordance with the present invention is applied to an electronic device that is capable of connecting to the Internet. The method of the present invention comprises acts of receiving a connecting request containing a web address of a target web page, searching and connecting to the target web page over the Internet based on the connecting request, capturing complete source codes of the target web page, analyzing the target web page, transforming contents in the target web page into multiple content objects, designating each content object with a unique number, duplicating the target web page layout to create an object selecting page having the content objects, receiving a selecting object request having the unique number of the selected content object from the object selecting page and establishing a capture rule having the web address of the target web page and the unique number of the selected content object. Therefore, it is easy for the user to select required contents in the target web page and establish a capture rule. The user can use the capture rule to acquire only the required content from the target web page.

Other objectives, advantages and novel features of the invention will become more apparent from the following detailed description when taken in conjunction with the accompanying drawings.

### BRIEF DESCRIPTION OF THE DRAWINGS

FIG. 1 is a system block diagram for implementing a method in accordance with the present invention;

FIG. 2 is a flow chart of a first embodiment of the method in accordance with the present invention;

FIG. 3 shows an object selecting page for selecting a content object;

FIG. 4 shows the object selecting page in FIG. 3 further having a preview block;

FIG. 5 shows a content display page for showing filtered content object for viewing;

FIG. 6 is a flow chart of implementing the capture rule established by the first embodiment of the method in accordance of the present invention;

FIG. 7 is a partial flow chart of a second embodiment of the method in accordance with the present invention;

FIG. 8 shows a sub-object selecting page for selecting sub-content object;

FIG. 9 shows the sub-object selecting page in FIG. 8 further having a preview block;

FIG. 10 is a flow chart of implementing the sub-capture rule established by the second embodiment of the method in accordance of the present invention;

FIG. 11 shows a sub-content display page for showing filtered sub-content object for viewing; and

FIG. 12 shows a conventional web page having text, pictures and Flash player.

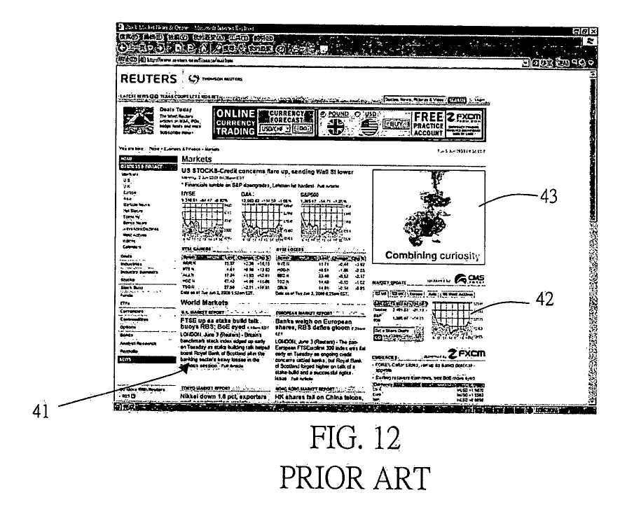

### DETAILED DESCRIPTION OF PREFERRED EMBODIMENT

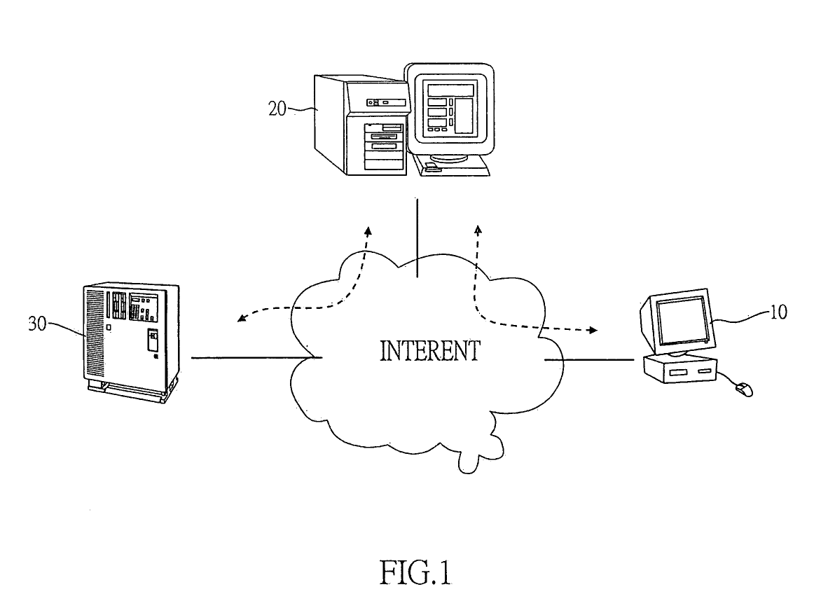

With reference to FIG. 1, a method in accordance with the present invention is applied to a local or a remote electronic device that connects to the Internet. The local electronic device may be a personal computer (10), a cell phone, a personal digital assistant (PDA) or the like and have a browser for browsing web pages. The remote electronic device may be a web page capture server (20) that allows users to connect to the web page capture server (20) over the Internet with their personal computers (10) or portable devices.

The electronic device further connects to a web server (30) currently existing on the Internet. The web server (30) provides multiple web pages. Each web page has contents that may be, but not limited to text, videos, pictures, music and the like. The technique for creating the web pages may be, but not limited to wireless application protocol (WAP), hypertext markup language (HTML), cascading style sheet (CSS), JavaScript, hypertext preprocessor (PHP), JavaServer pages (JSP), extensible hyper text markup language (XHTML), extensible markup language (XML), dynamic hypertext markup language (DHTML), java based statistical processor (JASP), application service provider (ASP), practical extraction and report language (PERL), Flash or the like.

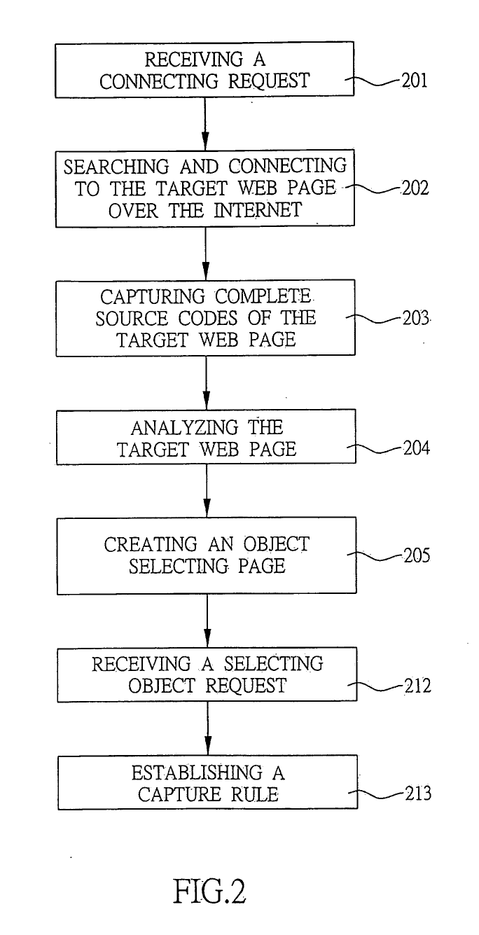

With further reference to FIG. 2, a first embodiment of the method of the present invention comprises acts as follows.

In the act of receiving a connecting request (201), the electronic device receives a connecting request that contains a web address of a target web page. The connecting request may be sent by the personal computer (10) to itself or to the web page capture server (20).

In the act of searching and connecting to the target web page over the Internet (202), the electronic device looks up and connects to the target web page over the Internet based on the web address in the connecting request.

In the act of capturing complete source codes of the target web page (203), the electronic device captures complete source codes of the target web page.

In the act of analyzing the target web page (204), the contents in the target web page are transformed into multiple content objects, and each content object is designated with a unique number. For example, if the source codes of a HTML script-encoded target web page are captured, a preferred embodiment for analyzing the target web page may use a HTML syntax analyzer to interpret the source codes of the target web page. Subsequently, all the contents in the target web page such as text, pictures, hyperlink settings and the like are transformed into multiple content objects and each content object is designated with a unique number.

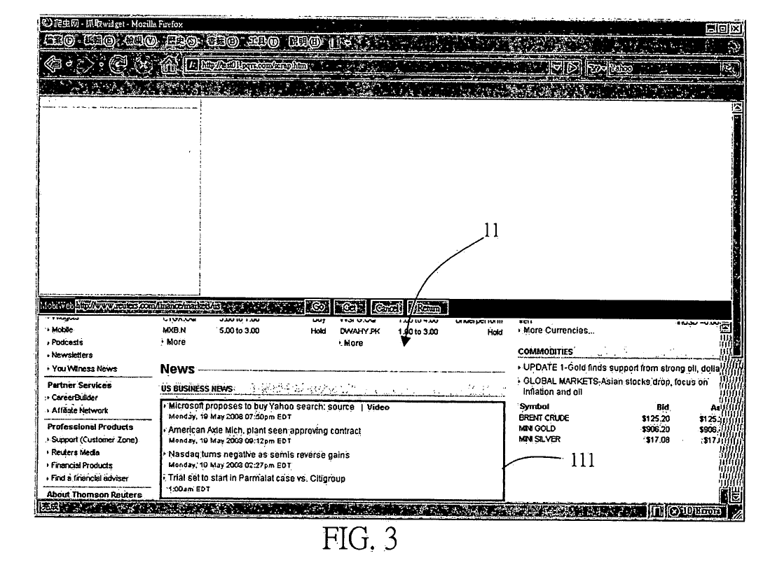

With further reference to FIG. 3, in the act of creating an object selecting page (205), a preferred embodiment for accomplishing this act is duplicating the target web page layout to create an object selecting page (11) with multiple content objects. The object selecting page (11) can be displayed by any browser in the personal computer (10) or the portable device. Furthermore, a logic program such as JavaScript is embedded in the object selecting page (11) to create multiple selecting frames (111) corresponding respectively to the content objects. When a cursor moves on one of the content objects, the corresponding selecting frame (111) will show up.

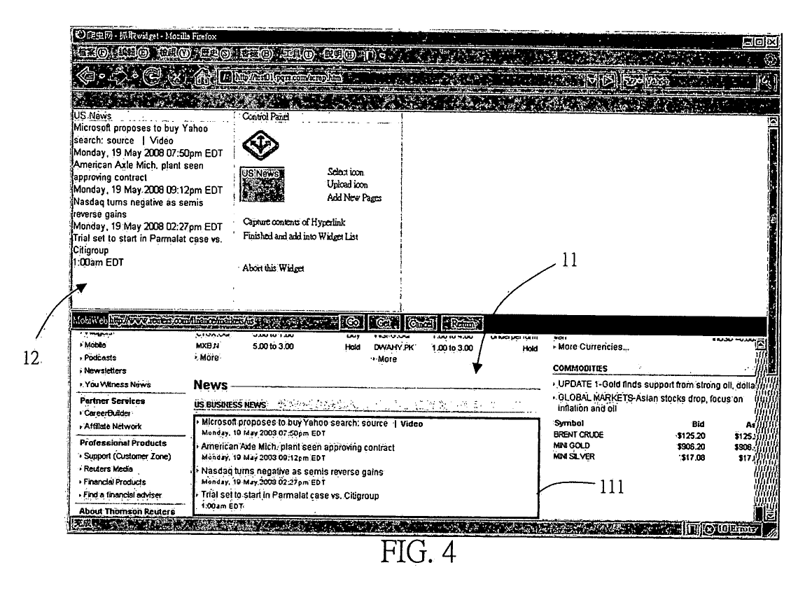

With further reference to FIG. 4, when the user selects one content object in the object selecting page (11), a preview block (12) is shown on the object selecting page (11) for confirming whether the selected content object is the desired information. Furthermore, if the content object comprises hyperlinks, the hyperlinks will be contained into the preview block (12).

In the act of receiving a selecting object request (212), the electronic device will receive a selecting object request that contains the unique number of the selected content object when the user finishes selecting required content object from the object selecting page (11).

In the act of establishing a capture rule (213), the electronic device establishes a capture rule having the web address of the target web page and the unique number of the selected content object.

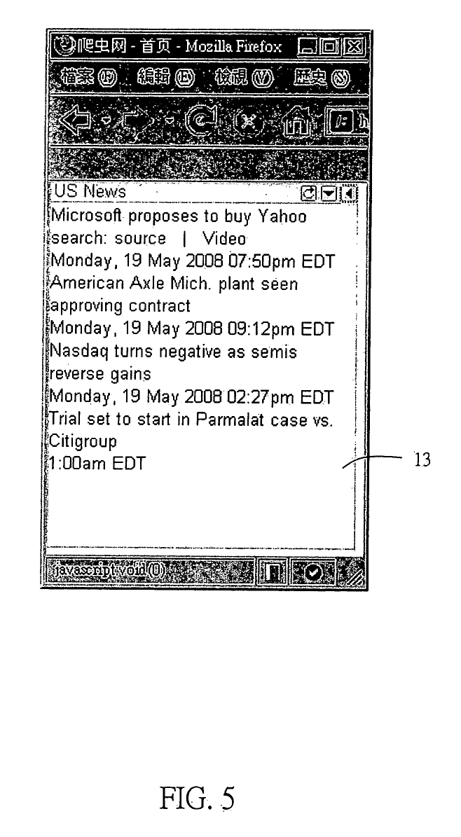

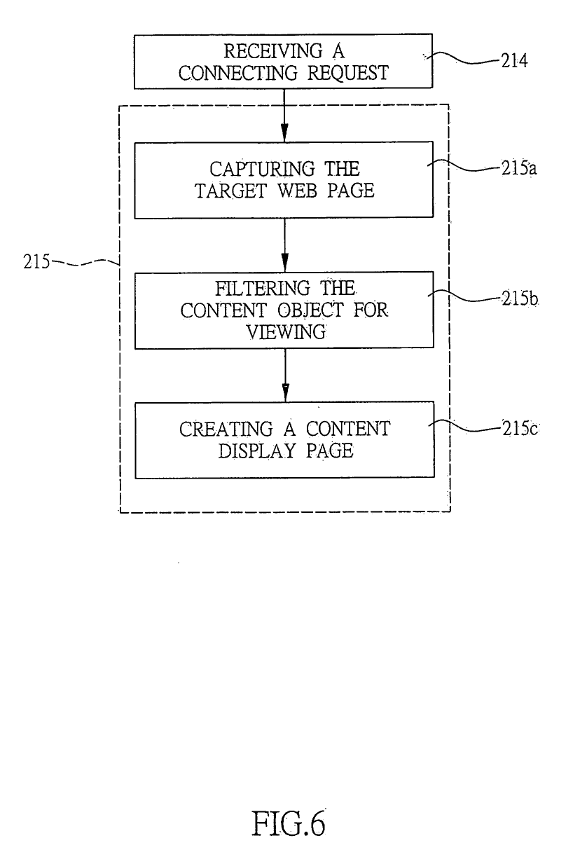

After the above-mentioned acts, the user can use the saved capture rule to acquire the required content from the target web page as shown in FIG. 5. With further reference to FIG. 6, a preferred embodiment for acquiring the required content comprises acts as follows.

In the act of receiving a connecting request (214), the electronic device receives a connecting request that has a command for designating the capture rule when the user intends to view the required content.

In the act of filtering the content object (215), the electronic device filters the content object that has the unique number consistent with the same saved in the designated capture rule from the target web page. A preferred embodiment of the act of filtering the content object (215) may further comprise sub-acts as follows.

In the sub-act of capturing the target web page (215a), the electronic device captures the target web page and transforms the contents in the target web page into multiple content objects for viewing. Each content object for viewing is designated with a unique number consistent with the unique number of the corresponding content object designated in the act of analyzing the target web page (204).

In the sub-act of filtering the content object for viewing (215b), the electronic device filters the content object for viewing that has the unique number consistent with the same saved in the designated capture rule from the target web page.

With reference to FIG. 5, in the act of creating a content display page (215c), the electronic device creates a content display page (13) that shows the filtered content object for viewing. If the filtered content object for viewing has hyperlinks, the hyperlinks will be contained in the content display page (13).

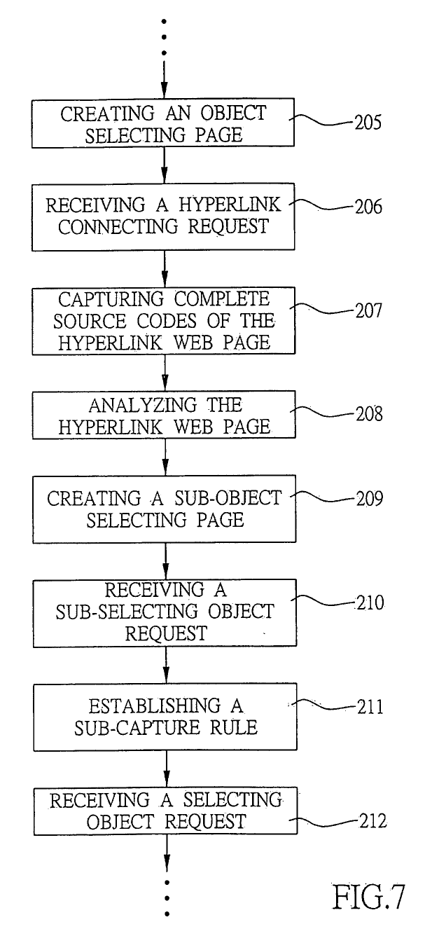

In addition, if the target web page only provides a brief introduction of each content, each content often has a corresponding hyperlink for further connecting to a web page having details of the content. Accordingly, the preview block (12) in the object selecting page (11) created by the act of creating an object selecting page (205) contains the hyperlinks the same as in the target web page. The user can operate the electronic device to select one of the hyperlinks in the object selecting page (11). After that, with reference to FIG. 7, comparing with the first embodiment of the method of the present invention, a second embodiment of the method of the present method further comprises acts as follows.

In the act of receiving a hyperlink connecting request (206), the electronic device receives a hyperlink connecting request from the object selecting page (11). The hyperlink connecting request has a web address of a hyperlink web page.

In the act of capturing complete source codes of the hyperlink web page (207), the electronic device captures complete source codes of the hyperlink web page over the Internet based on the web address of the hyperlink web page in the hyperlink connecting request.

In the act of analyzing the hyperlink web page (208), the electronic device transforms the contents in the hyperlink web page into multiple sub-content objects, and each sub-content object is designated with a unique number.

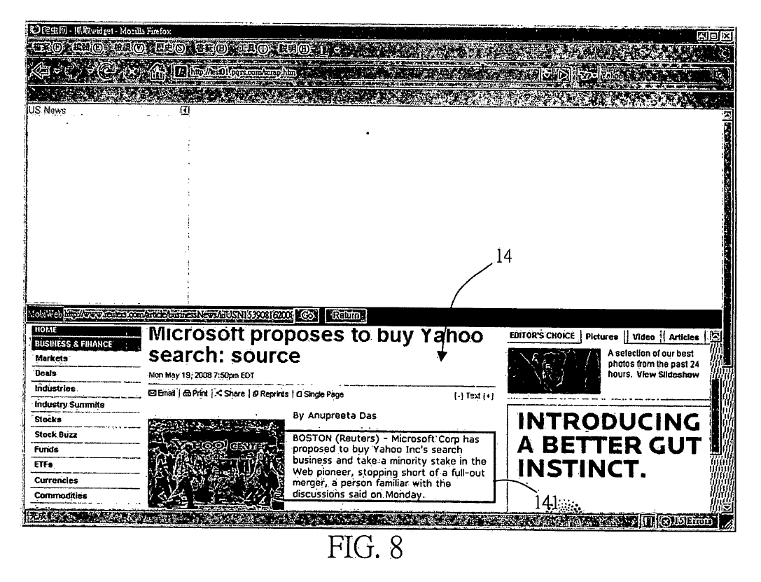

In the act of creating a sub-object selecting page (209), the electronic device creates a sub-object selecting page (14) that has the sub-content objects. With further reference to FIG. 8, the creation of the sub-object selecting page (14) is the same as the creation of the object selecting page (11). Furthermore, when the cursor moves on one of the sub-content objects, a selecting frame (141) corresponding to the sub-content object indicated by the cursor will show up.

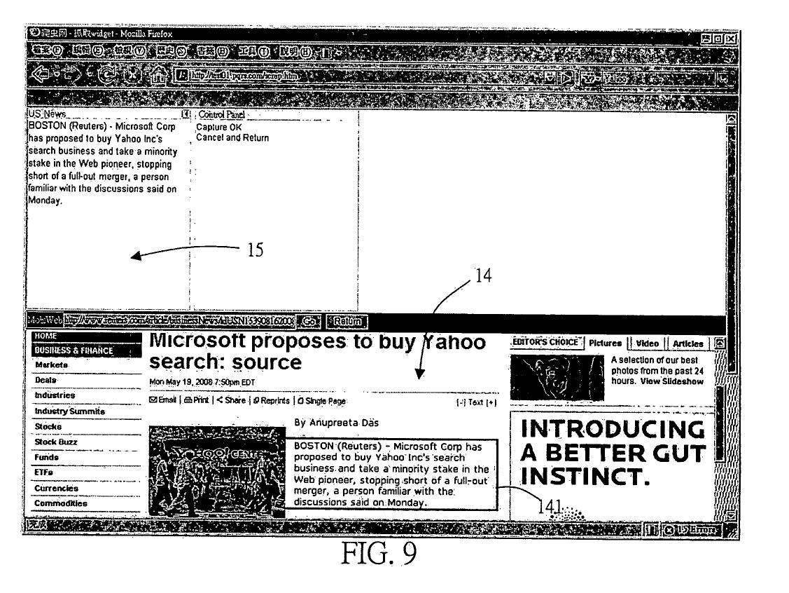

With further reference to FIG. 9, when the user selects one sub-content object in the sub-content object selecting page (14), a preview block (15) is created to display the selected sub-content object for confirming whether the selected content object is the desired information.

In the act of receiving a sub-selecting object request (210), the electronic device receives a sub-selecting object request that has the unique number of the selected sub-content object when the user finishes selecting required sub-content object from the sub-content object selecting page (14).

In the act of establishing a sub-capture rule (211), the electronic device establishes a sub-capture rule that contains the web address of the hyperlink web page and the unique number of the selected sub-content object.

Therefore, the act of establishing a capture rule (213) further saves the sub-capture rule in the corresponding capture rule.

Furthermore, if the selected content object contains hyperlinks, the content display page (13) created by the act of creating a content display page (215c) will contain the hyperlinks the same as in the selected content object.

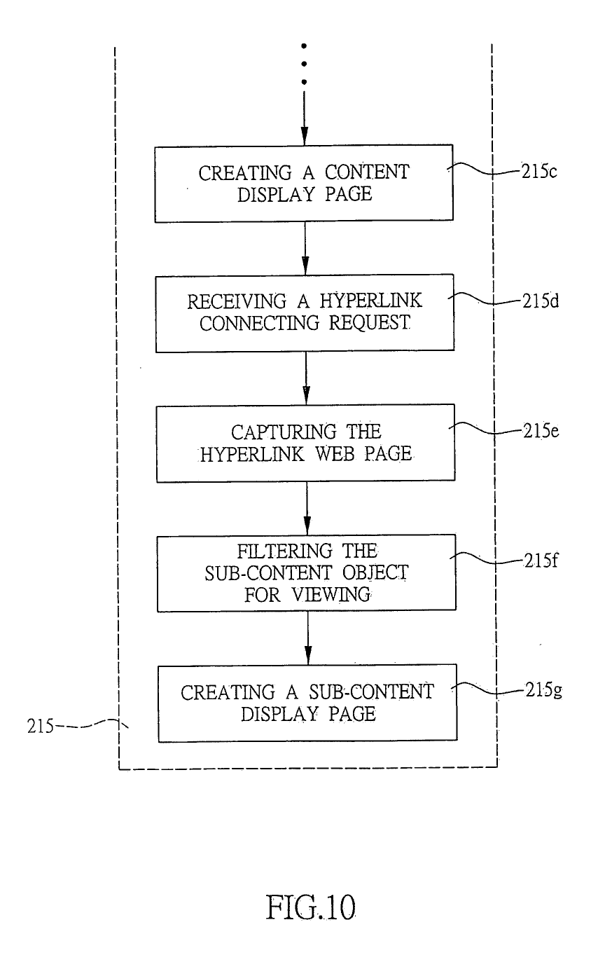

With reference to FIG. 10, after the user selects one of the hyperlinks in the content display page (13), the second embodiment of the method of the present further comprises acts as follows.

In the act of receiving a hyperlink connecting request (215d), the electronic receives a hyperlink connecting request that has a web address of a hyperlink web page from the content display page (13).

In the act of capturing the hyperlink web page (215e), the electronic device captures the hyperlink web page based on the web address in the hyperlink connecting request. The electronic device then transforms the contents in the hyperlink web page into multiple sub-content objects for viewing. Each sub-content object for viewing is designated with a unique number consistent with the unique number of the corresponding sub-content object designated in the act of analyzing the hyperlink web page (208).

In the act of filtering the sub-content object for viewing (2150, the electronic device filters the sub-content for viewing that has the unique number consistent with the same saved in the sub-capture rule in the designated capture rule from the hyperlink web page.

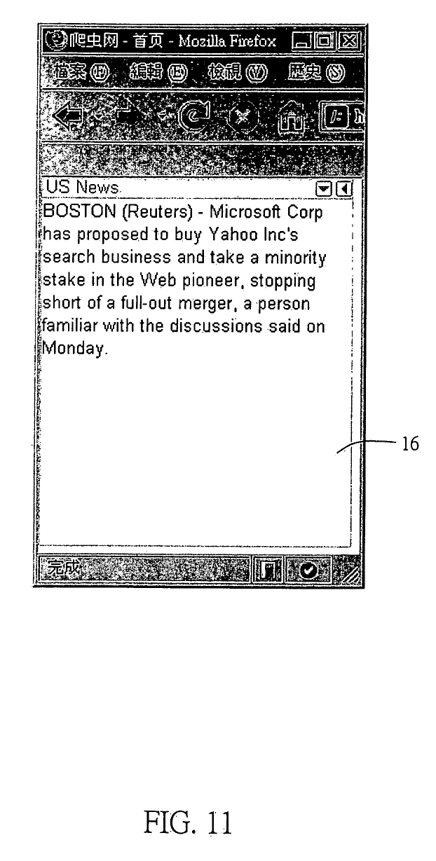

With further reference to FIG. 11, in the act of creating a sub-content display page (215g), the electronic device creates a sub-content display page (16) that shows the filtered sub-content object for viewing.

Because websites that provide real-time updated news, stock quotes information or the like require updating real-time information frequently, each website host of those websites often creates a template web page. The template web page has common contents so the website host adds only the newly updated information, pictures and the like to the template web page to create a new web page having the common contents and the newly updated information, pictures and the like. Accordingly, the website host can easily update the website. Therefore, the method of the present invention is especially suited to the websites having web pages made by the template web page because no matter how often the target web page is updated, the user still can easily acquire required contents in the target web page once the user has set a capture rule of the target web page.

That is, the user needs not to create distinct sub-capture rule for each hyper link in the content display page (13). In stead, the user creates a sub-capture rule for only one sub-content object, and the same rule can be applied to all sub-content objects automatically.

Based on the foregoing descriptions, the method of the present invention has advantages as follows.

1. It is not necessary for the user to know the HTML script well when selecting required contents in the target web page. The user only requires selecting required content object in the object selecting page (11) and establishing a capture rule for the required content object. The user also can establish multiple capture rules for different content objects in one target web page or respectively in different target web pages. Therefore, the user can operate the electronic device implementing the method of the present invention or operate another electronic device to connect to the electronic device implementing the method of the present invention to select the required capture rule. The electronic device implementing the method of the present invention will capture the required contents based on the selected capture rule and shows the required contents to the user.

2. If the hyperlink settings in one target web page are used to connect to the hyperlink web pages that are created from the same template web page, it is easy for the user to browse required contents in different hyperlink web pages once the user has established a sub-capture rule of the hyperlink web pages created from the same template web page. It is not necessary for the user to establish many different capture rules for the target web pages created from the same template web page.

3. When the computers or portable devices have only limited resources, such as limited connection bandwidth, limited memory capacities, limited computing power or the like, it is extremely difficult for the computers or portable devices to display the whole contents in the target web page. The method of the present invention allows capturing required contents in the target web page and filtering out unnecessary contents to avoid influence of the bad conditions on the computers or portable devices showing required contents.

Even though numerous characteristics and advantages of the present invention have been set forth in the foregoing description, together with details of the structure and function of the invention, the disclosure is illustrative only. Changes may be made in detail, especially in matters of arrangement of parts within the principles of the invention to the full extent indicated by the broad general meaning of the terns in which the appended claims are expressed.

What is claimed is:

1. A method of selecting objects in web pages applied to an electronic device that is capable of connecting to the Internet, and the method comprising acts of:
receiving a connecting request containing a web address of a target web page;
searching and connecting to the target web page over the Internet based on the connecting request;
capturing complete source codes of the target web page;
analyzing the target web page, wherein the contents in the target web page are transformed into multiple content objects, and each content object is designated with a unique number;
duplicating the target web page layout to create an object selecting page having the content objects;
receiving a selecting object request containing the unique number of the selected content object from the object selecting page; and
establishing a capture rule having the web address of the target web page and the unique number of the selected content object.

2. The method as claimed in claim 1, wherein
the object selecting page contains hyperlinks if the selected content in the target web page contains the hyperlinks;
after the act of receiving a selecting object request, the method further comprises acts of:
receiving a hyperlink connecting request containing a web address of a hyperlink web page;
capturing complete source codes of the hyperlink web page over the Internet based on the hyperlink connecting request;
analyzing the hyperlink web page, wherein contents in the hyperlink web page are transformed into multiple sub-content objects, and each sub-content object is designated with a unique number;
duplicating the hyperlink web page layout to create a sub-object selecting page having the sub-content objects;
receiving a sub-selecting object request containing the unique number of the selected sub-content object from the sub-object selecting page; and
establishing a sub-capture rule having the web address of the hyperlink web page and the unique number of the selected sub-content object; and
the act of establishing a capture rule having the web address of the target web page and the unique number of the selected content object further saves the sub-capture rule in the corresponding capture rule.
